(19) United States
(12) Patent Application Publication
(10) Pub. No.: US 2014/0196803 A1
(43) Pub. Date: Jul. 17, 2014

(54) VALVE SUBASSEMBLY

(71) Applicant: Robert Bosch GmbH, Stuttgart (DE)

(72) Inventors: Oliver Gaertner, Abstatt (DE); Daniel Gosse, Berlin (DE)

(73) Assignee: Robert Bosch GmbH, Stuttgart (DE)

(21) Appl. No.: 14/149,041

(22) Filed: Jan. 7, 2014

(30) Foreign Application Priority Data
Jan. 14, 2013 (DE) 10 2013 200 417.6

(51) Int. Cl. F16K 15/02

(52) U.S. Cl. CPC F16K 15/026
USPC 137/535

(57) ABSTRACT

A valve subassembly for arrangement on a valve device is disclosed. The valve subassembly includes a valve closing body configured to be placed on and raised from an associated valve seat. The valve subassembly also includes a return element configured to reset the valve closing body against the valve seat and a valve cover configured to close an associated valve housing. The valve cover, the return element, and the valve closing body are connected to one another in a captive manner.

This application claims priority under 35 U.S.C. §119 to patent application number DE 10 2013 200 417.6, filed on Jan. 14, 2013 in Germany, the disclosure of which is incorporated herein by reference in its entirety.

### BACKGROUND

The disclosure relates to a valve subassembly for arrangement on a valve device having a valve closing body for placing on and raising from an associated valve seat, a return element for resetting the valve closing body against the valve seat and a valve cover for closing an associated valve housing. The disclosure furthermore relates to a use of a valve subassembly of this kind in a pump element.

Valve subassemblies of the type in question are used in pump elements which deliver fluid. In particular, pump elements of this kind are used in hydraulic units of vehicle brake systems, e.g. ABS and ESP, to make available a controlled brake pressure by means of a brake fluid as a fluid. The single pump element comprises a pump cylinder and a pump plunger, which is mounted in an axially movable manner therein. When the pump plunger moves out of the pump cylinder, fluid is sucked into the pump cylinder via an inlet valve by means of a vacuum or suction produced as it does so. When the pump plunger subsequently moves in, the fluid sucked in is pumped out of the pump cylinder again under pressure through an outlet valve in order to perform work.

Conventional valves, i.e. inlet valves and outlet valves, comprise a valve closing body, which is urged against a valve seat by a return element. Here, the return element and the valve closing body are arranged coaxially as individual components in a housing, which serves as a valve cover. This valve cover housing encloses both the valve closing body and the return element.

### SUMMARY

According to the disclosure, a valve subassembly is provided for arrangement on a valve device having a valve closing body for placing on and raising from an associated valve seat, a return element for resetting the valve closing body against the valve seat and a valve cover for closing an associated valve housing. In this case, the valve cover, the return element and the valve closing body are connected to one another in a captive manner.

A valve opening, which can be closed or opened selectively by the valve closing body, is formed in the valve seat of the valve device or valve. In the case of an outlet valve, fluid flows under the action of pressure against the valve closing body and raises the valve closing body, and fluid flows out of the pump cylinder through the valve opening. Under the action of suction, the valve closing body is raised from the valve seat, and the fluid can be sucked into the pump cylinder through the valve opening of the inlet valve. If the action of pressure or the action of suction slackens, the return element urges the valve closing body against the valve seat until the valve closing body is once again resting in a sealing manner on the valve seat and thus closes the valve.

With the valve subassembly according to the disclosure, the valve closing body is connected in a captive manner to the return element and the valve cover or closing cover. As a result, a valve subassembly is formed, the components of which are joined together in such a way that they are connected securely or non-detachably. The valve subassembly can therefore be handled as a complete subassembly without the risk of loss and can be preassembled in advance at a production plant. Moreover, only a single assembly step is required during final assembly to mount the valve subassembly according to the disclosure on the valve device.

Furthermore, the valve subassembly according to the disclosure is easy to position and mount during the installation of the valve cover. Fixing the valve cover on the valve housing simultaneously determines the position of the valve subassembly and, at the same time, also positions the valve closing body relative to the valve seat. The return element is arranged in between and resiliently preloaded. Thus, a valve subassembly is formed which can be arranged as such on the associated valve and then forms a part of said valve. The position of the valve cover is also clearly defined by means of the valve closing body connected thereto, since the valve closing body must cover the valve opening. As a result, the valve subassembly can be mounted on the associated valve device in a particularly simple manner and without the risk of error.

In the valve subassembly according to the disclosure, it is advantageous that the valve cover is coupled in a captive manner to the return element, and the return element is coupled in a captive manner to the valve closing body. Coupling is carried out, in particular, one after the other in the sequence stated. With the components coupled one after the other in this way, the pressure force or suction force exerted by the fluid and leading to the raising of the valve closing body can be transmitted first to the valve closing body, then to the return element and subsequently to the valve cover. With such continuous force transmission one after the other to the individual components, the components are subject to particularly gentle loading, with the result that a very low-wear valve subassembly is created.

The return element, the valve subassembly and the valve device are preferably arranged coaxially with one another. Hence, the forces mentioned can be transmitted in a linear manner, and therefore no friction losses arise due to transverse forces which would otherwise occur.

According to the disclosure, the return element is furthermore advantageously formed by a helical spring, in particular by a cylindrical helical spring. The helical spring has a longitudinal extent which extends along the longitudinal axis of the valve subassembly. The helical spring can be subjected to particularly large deformation along the spring axis thereof. In the case of a particularly large fluid pressure or suction, this means that the valve closing body can be raised by a correspondingly large amount from the valve seat. A quantity of fluid per unit time corresponding to the fluid pressure or suction can flow out or flow in, thus ensuring a high delivery rate.

According to the disclosure, the return element particularly advantageously has a spiral shape, when viewed in the direction of the longitudinal axis of the valve device. This provides a particularly space-saving return element in relation to the longitudinal extent of the valve subassembly. The spiral shape has two end regions, of which one end region is provided with a larger diameter and the second end region is provided with a smaller diameter. In particular, the return element is coupled at the smaller diameter to the valve cover and at the larger diameter to the valve closing body. In this way, the valve closing body can be surrounded or ringed in a space-saving manner by the larger diameter of the return element. Preferably, a slight spiral shape is formed with only a small difference in the diameters of the two end regions, thus creating a particularly stable spiral.

A spiral-shaped helical spring, the longitudinal axis of which extends along the axis of the valve device and which is configured with a conical shape or is of cone-shaped configuration, is preferably provided as a return element. Moreover, the spiral-shaped helical spring has turns which can, in particular, be pushed one inside the other when compressed, thus allowing optimum used to be made of available space. Combining the spiral shape with the helical spring provides a return element which combines the advantages stated there. This means that the return element according to the disclosure can be deformed by a particularly large amount and, at the same time, is particularly space-saving.

According to the disclosure, the return element is furthermore advantageously secured on an elevation provided on the valve cover, in particular being pulled on there. The return element is secured by means of one of its two end regions on the elevation on the valve cover. The elevation provides a marker at which the return element can be mounted reliably in position, simplifying the production of the valve subassembly overall. In particular, the return element has an elongated basic shape, is preferably cylindrical or slightly cone-shaped and is furthermore configured as a helical spring, in particular. Configured in this way, the return element can be pulled onto the elevation according to the disclosure in a particularly simple and stable manner and hence secured on the valve cover. As an alternative, the return element is pressed together with the elevation or pressed onto the elevation using a pressure punch.

It is particularly advantageous if the elevation according to the disclosure is of cylindrical configuration. The elevation thus forms a mandrel on which the return element is secured, in particular being pulled onto the latter. In this case, the return element is widened radially and rings the elevation at the outer circumference thereof. The radial widening gives rise to spring forces which act radially inwards and which hold the return element securely on the elevation or mandrel. The elevation is preferably configured with latching grooves, in which an end region of the return element is arranged in a particularly stable manner by a latching action.

As a particularly preferred option, the elevation is arranged in the center of the valve cover and, overall, coaxially with the longitudinal axis of the valve device. The valve cover is preferably of rotationally symmetrical configuration, as are particularly preferably also the other components of the valve subassembly, namely the return element and the valve closing body. In conjunction with the coaxial elevation, this provides a radially rotationally symmetrical valve subassembly with a coaxially arranged valve cover, return element and valve closing body, which subassembly can furthermore be positioned coaxially with the valve device. Overall, it is thereby possible to produce a particularly space-saving valve device in which, furthermore, no disruptive transverse forces act on the individual components.

Moreover, the valve cover is preferably of disk-shaped configuration and is thus of very space-saving configuration in the longitudinal extent thereof.

According to the disclosure, the valve closing body is furthermore advantageously connected positively to the return element. By means of the positive engagement, the two components, the return element and the valve closing body, engage in one another, and, in particular, the return element reaches around the valve closing body. This ensures that the position of the valve closing body is very stable in several directions. Precisely as fluid flows around, the connection between the return element and the valve closing body is under a high dynamic force effect due to the powerful flow movements of the fluid acting there. By means of the positive engagement according to the disclosure, a particularly stable connection appropriate to requirements is provided.

It is particularly advantageous if the positive connection according to the disclosure is formed by means of an overmolding. The overmolding is produced by an injection molding operation, in particular by plastic injection molding. This positive connection is very simple to produce and, at the same time, is particularly stable.

According to the disclosure, the return element is furthermore advantageously connected nonpositively to the valve cover, in particular placed on or pulled onto the elevation of the valve cover. This gives a stable and, at the same time, simple and low-cost connection between the valve cover and the return element by means of nonpositive engagement. At the same time, this nonpositive connection according to the disclosure is very well matched to the prevailing flow conditions in a manner appropriate to requirements. In the vicinity of the valve cover, the dynamic force effect due to the flow movements of the fluid is less than in the vicinity of the valve closing body.

The disclosure is accordingly furthermore directed at a use of a valve subassembly of this kind in a pump element, in particular of a hydraulic unit of a vehicle brake system. In this case, the valve subassembly is connected to a pump housing of the pump element by means of the valve cover. Purely by means of the valve cover, the position of the other components of the valve subassembly, namely of the return element and of the valve closing body, in the pump element is fixed. This allows simple mounting of all three combined components on the pump housing in one step, in particular by means of staking, ultrasonic welding, screwing or clipping. Overall, a simplified and very space-saving pump element is created at low cost. With a pump element of this kind, there is, in particular, less demand for installation space in the hydraulic unit as compared with known pump elements which have a valve cover housing.

### BRIEF DESCRIPTION OF THE DRAWINGS

An illustrative embodiment of the solution according to the disclosure is explained in greater detail below by means of the attached schematic drawings, in which:

FIG. 1 shows a cutaway portion of a perspective oblique view of a pump element having a valve subassembly in accordance with the prior art,

FIG. 2 shows a perspective oblique view of an illustrative embodiment of a valve subassembly according to the disclosure, and

FIG. 3 shows a longitudinal section of the illustrative embodiment shown in FIG. 2, installed in a pump element according to the disclosure.

### DETAILED DESCRIPTION

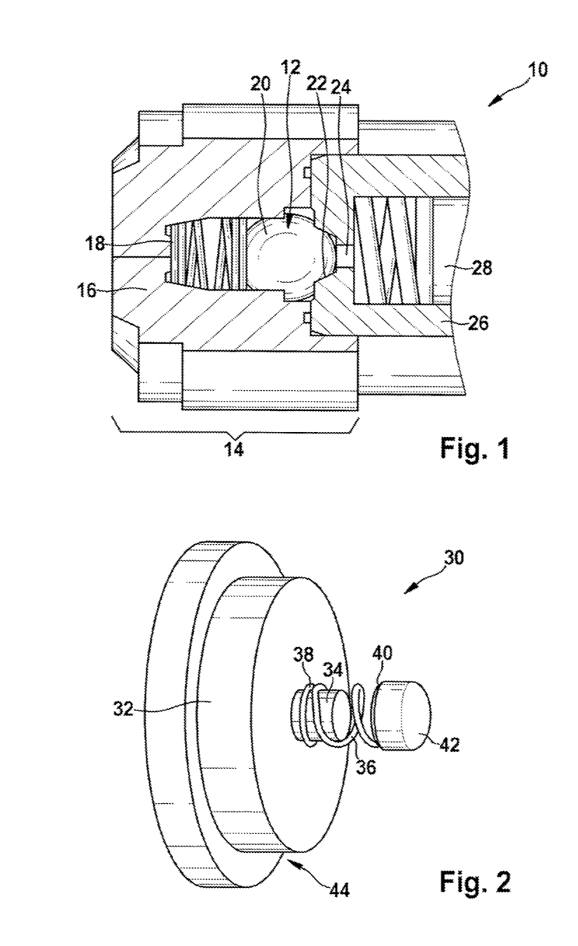

FIG. 1 shows a cutaway portion of a known pump element 10 of a hydraulic unit of a vehicle brake system. In particular, the cutaway portion shows an outlet valve as a valve device 12. The valve device 12 comprises a valve subassembly 14 having a sleeve-shaped valve cover housing 16, a return element 18 and a spherical valve closing body 20 as individual components. In this case, the return element 18 and the valve closing body 20 are arranged in the valve cover housing 16 coaxially with the longitudinal axis of the pump element 10 and are encased by said housing. The valve closing body 20 is furthermore urged against a valve seat 22 by means of the return element 18, which in the present case is configured as a resiliently preloaded helical spring. Centrally in the valve seat 22 there is a valve opening 24, which can be closed or opened selectively by means of the valve closing body 20.

To open the valve opening 24 and hence the valve device 12, fluid in an associated pump cylinder 26 is forced against the valve closing body 20 by means of a pump plunger 28. During this process, the pressurized fluid raises the valve closing body 20 and flows out. If the pressure exerted by the fluid on the valve closing body 20 is less than the pressure exerted by the return element 18, the valve closing body 20 is pushed back against the valve seat 22 in a sealing manner. The valve opening 24 is then closed again.

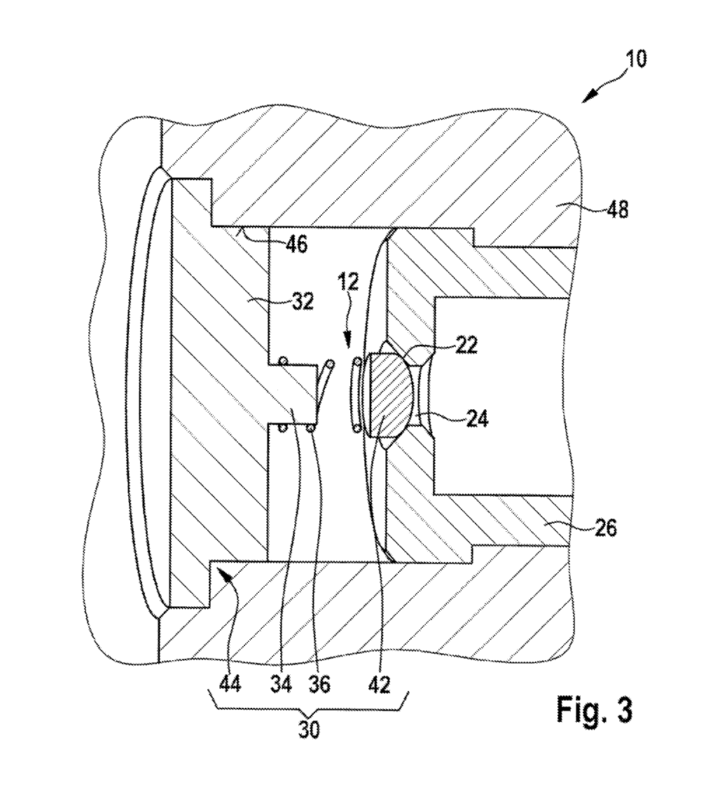

FIG. 2 and FIG. 3 illustrate a valve subassembly 30 according to the disclosure, which is used in a pump element 10 on a valve device 12. In the present case, the valve device 12 is an outlet valve.

In detail, the valve subassembly 30 according to the disclosure comprises a disk-shaped valve cover 32, in the center of which a cylindrical elevation 34 or mandrel is formed. The end region 38 of a helical spring as a return element 36 is pulled onto this cylindrical elevation 34. In this case, the helical spring is widened radially at the end region 38 until the end region 38 of the helical spring rings the elevation 34 at the outer circumference thereof. Radially inward-acting spring forces brought about by means of the radial widening hold the return element 36 in a particularly stable manner on the elevation 34. Here, the helical spring is made from spring wire.

The return element 36 is slightly conical in the longitudinal extent thereof, with the result that the opposite end region 40 from end region 38 has a larger diameter than end region 38. The return element 36 is thus a slightly spiral-shaped helical spring, the turns of which can be pushed one into the other when compressed, with the result that the space requirement in the axial direction is minimal

A valve closing body 42 is furthermore molded positively onto the end region 40 of the return element 36 by means of an injection molding process. In the present case, the valve closing body 42 is a cylinder which has a curved surface in the form of a spherical cap in the direction of the valve seat 22. By means of this curved surface, the valve opening 24 at the valve seat 22 is sealed off in a particularly effective manner. In alternative variants (not shown), the valve closing body 20 can also have the shape of a spherical cap, a hemisphere or a sphere.

As an alternative, the connection between the valve closing body 42 and the return element 36 is produced by means of nonpositive engagement, in particular by being pushed or clipped on.

Overall therefore, according to the disclosure, the valve cover 32 is connected in a captive manner to the return element 36, and the return element 36 is connected in a captive manner to the valve closing body 42. This gives a valve subassembly 30 which can be pre-produced as a single component in large plants, saving costs and materials. The valve subassembly 30 can furthermore be handled as a complete subassembly without the risk of loss. Moreover, the valve subassembly 30 according to the disclosure can be installed in a single step without the risk of error during the assembly of the pump element 10.

In addition, the valve subassembly 30 requires little installation space and can be installed in a particularly space-saving manner in a pump element 10. For this purpose, a step 44 is furthermore provided in the disk-shaped valve cover 32, said step being complementary to an inner contour 46 of a valve housing 48 which simultaneously forms a pump housing. At this step 44, the valve cover 32 is staked to the valve housing 48.

What is claimed is:

1. A valve subassembly for arrangement on a valve device, the valve subassembly comprising:
a valve closing body configured to be placed on and raised from an associated valve seat;
a return element configured to reset the valve closing body against the valve seat; and
a valve cover configured to close an associated valve housing,
wherein the valve cover, the return element, and the valve closing body are connected to one another in a captive manner.

2. The valve subassembly according to claim 1, wherein:
the valve cover is coupled in a captive manner to the return element, and
the return element is coupled in a captive manner to the valve closing body.

3. The valve subassembly according to claim 1, wherein the return element is a helical spring.

4. The valve subassembly according to claim 1, wherein the return element has a spiral shape.

5. The valve subassembly according to claim 1, wherein the return element is secured on an elevation provided on the valve cover.

6. The valve subassembly according to claim 5, wherein the elevation has a cylindrical configuration.

7. The valve subassembly according to claim 1, wherein the valve closing body is connected positively to the return element.

8. The valve subassembly according to claim 7, wherein the positive connection is formed by an overmolding.

9. The valve subassembly according to claim 1, wherein the return element is connected nonpositively to the valve cover.

10. The valve subassembly according to claim 1, wherein the valve subassembly is configured for use in a pump element.

11. The valve subassembly according to claim 10, wherein the pump element is a hydraulic unit of a vehicle brake system.

12. The valve subassembly according to claim 5, wherein the return element is configured to be pulled onto the elevation on the valve cover.
